(19) United States
(12) Patent Application Publication
(10) Pub. No.: US 2026/0336606 A1
(43) Pub. Date: Oct. 29, 2026

(54) FUSION BETWEEN DRIVER EYE GAZE MONITORING AND OBJECT DETECTION

(71) Applicant: Atieva, Inc., Newark, CA (US)

(72) Inventor: Jay Patel, Union City, CA (US)

(21) Appl. No.: 19/193,715

(22) Filed: Apr. 29, 2025

(51) Int. Cl. B60W 30/09; B60W 40/08; G06V 20/59

(52) U.S. Cl. CPC B60W 30/09; B60W 40/08; G06V 20/597

(57) ABSTRACT

This disclosure provides systems, apparatus, and methods, including computer programs encoded on storage media, for activating a driver assistance control using an intent and interaction of a driver and an object determined based on a combination of an eye gaze and a gesture of a driver of a vehicle. In some implementations, the method can include obtaining driver data including gaze data of a driver. Additionally, the method can include obtaining an environment model based on sensor data. The method can additionally include detecting an object based on a combination of the driver data and the environment model. The method can further include determining an interaction of the driver with the object based on the combination of the driver data and the environment model. The method can furthermore include activating, based on the interaction, a driver assistance control to control the vehicle.

### TECHNICAL FIELD

The present disclosure relates generally to automobiles, and more particularly, to a method and apparatus for a driver assistance system to control a vehicle based on an interaction between the driver of the vehicle and the object.

### BACKGROUND

Modern vehicles increasingly incorporate advanced driver assistance systems (ADAS) to improve safety. However, existing ADAS, through multiple integrated subsystems, may have limitations in detecting objects under various conditions and activating functional operations (e.g., collision avoidance, lane management, etc.) of the vehicle. For example, conventional ADAS rely primarily on environmental detection through sensors. While these sensors provide basic environmental awareness, they operate in isolation without other inputs. In addition, these sensors may not adequately address dynamic situations involving pedestrians, cyclists, other vehicles, etc.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In aspects of the disclosure, a method, a computer-readable medium, and an apparatus are provided. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some embodiments, a method can include obtaining driver data including gaze data of a driver. The method can additionally include obtaining an environment model based on sensor data. The method can further include detecting an object based on a combination of the driver data and the environment model. The method can also include determining an interaction of the driver with the object based on the combination of the driver data and the environment model. In addition, the method can include activating, based on the interaction, a driver assistance control to control the vehicle.

Other embodiments of this aspect include corresponding computer systems, apparatus, and computer programs recorded on one or more computer storage devices, each configured to perform the actions of the methods.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### DESCRIPTION OF THE DRAWINGS

The present invention is illustrated by way of example and not limitation in the figures of the accompanying drawings in which like references indicate similar elements.

FIG. 1 illustrates an advanced driver assistance system (ADAS) for activating a driver assistance control using an intent and interaction of a driver and an object, in accordance with some embodiments.

FIG. 2 illustrates a scenario in which the embodiments as described in FIG. 1 can be implemented, in accordance with some embodiments.

FIG. 3 illustrates a scenario in which the embodiments of the present disclosure can be implemented, in accordance with some embodiments.

FIG. 4 illustrates a scenario in which the embodiments of the present disclosure can be implemented, in accordance with some embodiments.

FIG. 5 is a data flow diagram of a method of selecting and implementing a driver assistance control using an intent and interaction of a driver and an object in accordance with some embodiments.

FIG. 6 is a block diagram illustrating some embodiments of a driver assistance system, in accordance with some embodiments.

FIG. 7 illustrates system level diagram of a vehicle, in accordance with some embodiments.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” or “example” or “implementation” means that a particular feature, structure, or characteristic described in connection with the embodiment can be included in at least some embodiments of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure. The terms “electric vehicle” and “EV” may be used interchangeably and refer to an all-electric vehicle.

Existing advanced driver assistance system (ADAS) suffers from several drawbacks. For example, decision making implementations of the ADAS may rely solely on external sensors without the integration of real-time driver behavioral inputs. External sensors may suffer from limited visibility in adverse weather, signal interference, angular resolutions, etc.

Aspects of the present disclosure address the above-noted and other deficiencies by using a fusion between eye gaze monitoring and human gesture detection and detected objects to determine an intent of the driver and interaction of the driver with the object; and activate, based on the interaction, a driver assistance control. Embodiments disclosed herein can increase safety operations of the vehicle, by interpreting driver behavioral inputs, intent, and the interaction of the driver with the surrounding environment (e.g., outside of the driver's vehicle). to proactively activate the ADAS decision making process. Embodiments disclosed herein can reliably detect objects approaching or within a crosswalk and proactively initiate the driver assistance control (e.g., adjust vehicle speed) to reduce collision risk.

As will be described below, embodiments disclosed herein can be applied in various applications including decision making, activating speed adjustment and stop operations during emergency or driver impairment, activating cruise control operations, activating following distance modification, activating speed limiting functions, activating stopping functions, activating parking operations, activating vehicle motion control, etc.

As will be described in detail below, various automotive control components and systems can be activated, using a combination of gaze and hand gesture technology, without the need for the driver to apply force on the brake pedal or use the voice command.

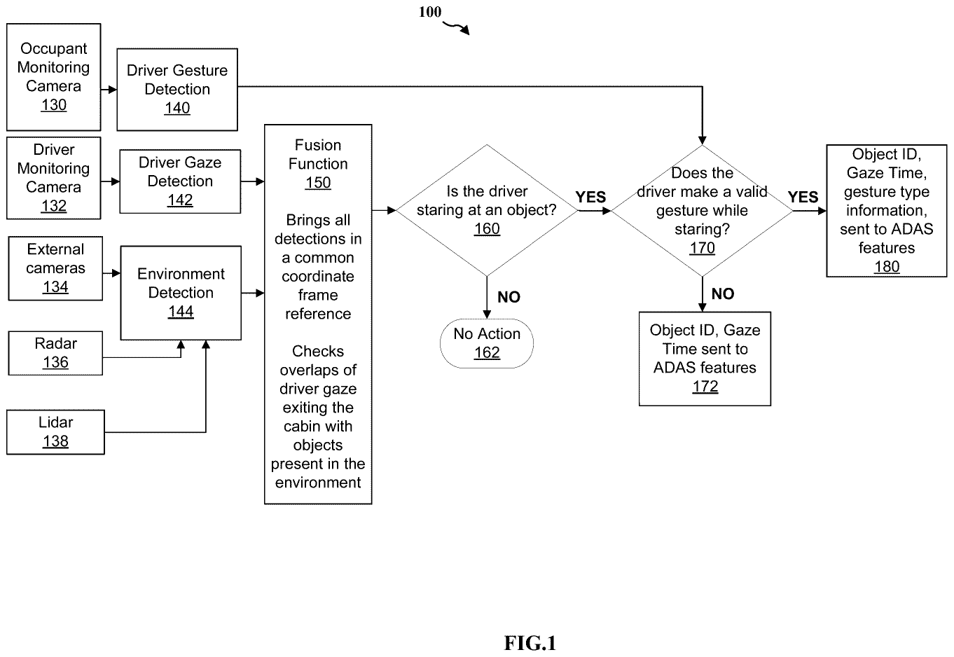

FIG. 1 illustrates an ADAS 100 for activating a driver assistance control using an intent and interaction of a driver and an object, in accordance with some embodiments. The ADAS 100 includes an occupant monitoring camera 130, a driver monitoring camera (DMC) 132, radar 136, Light Detection and Ranging (LIDAR) 138.

Occupant monitoring camera 130 can be configured for driver gesture detection 140. For example, a Red, Green, Blue-Infrared (RGB-IR) based occupant monitoring camera can be used for the detection of the driver gesture. Occupant monitoring camera 130 captures simultaneous RGB-IR image pairs and performs real-time image processing for hand gestures including, but not limited to: hand pose estimation, finger position tracking, motion vector analysis, temporal gesture sequence recognition, spatial coordinate mapping, etc. In some embodiments, the driver gesture detection 140 enables detection of static hand gestures including: palm positions, finger configurations, hand orientations. In some embodiments, the driver gesture detection 140 also enables detection of dynamic gestures including swipe movements, pointing actions, grip adjustments, complex motion patterns, etc. For example, the driver gesture detection 140 can detect a driver gesture, such as, for example, waving at a pedestrian, cyclist, one or more vehicles at an intersection of a road. Note that in some other embodiments, the occupant monitoring camera 130 can be used to also detect the Driver gaze if needed.

Gaze sensors, such as, the DMC 132 can be configured for driver gaze detection 142. For example, the driver gaze detection 142 obtains driver data including gaze data of the driver using the DMC 132. The output of driver gaze detection 142 can include a location of the driver's eyes and a vector describing the gaze angle of the driver's eyes. The location and the vector are as a function of the DMC coordinate ordinate system.

In some embodiments, the driver gaze detection 142 uses gaze technology to determine user inputs (e.g., gaze of a driver)and interprets the gaze of the driver direction to initiate the driver assistance control. In some embodiments, driver gaze detection 142 can receive, from gaze sensors (e.g., DMC 132), gaze data indicative of the eye gaze of the driver of the vehicle. In some embodiments, the gaze sensors can include multiple cameras positioned in various locations within the vehicle can capture gaze data indicative of the eye gaze of the driver. A gaze sensor, such as, for example, DMC 132, can be mounted to a pillar of the vehicle and directed to view the driver of the vehicle. Further placements could be devised in further embodiments. Another gaze sensor such as, for example, a driver and occupant monitoring camera (DOMC) (not shown), can be mounted to an overhead console and aimed to view the driver and occupant of the vehicle, i.e., occupants of front seats, and can also be aimed to view occupants of rear seats. DMC 132 can be integrated with the steering wheel column providing a clear view of driver's face and eyes. Further placements could be devised in further embodiments. It is understood the camera(s) are coupled to appropriate system component(s) to implement image capture or video capture and further processing (e.g., image processing, blink processing, etc.) for gaze detection. Note that other sensors capable of determining an eye gaze (e.g., eye-tracking sensors, infra-red (IR) sensors, IR cameras, etc. ,) can be used in conjunction with the system and method of the present disclosure.

After receiving the gaze data, the driver gaze detection 142 can determine, based on the gaze data, that the driver of the vehicle is looking at an object (e.g., a pedestrian, a cyclist, another vehicle, etc.). The driver gaze detection 142 utilizes angular ranges for gaze detection and captured images for determining the gaze direction of the driver. The driver gaze detection 142 can determine the gaze of the driver by monitoring head and/or eyes of a driver, which may be done by the DMC 132 and processing in the driver gaze detection 142. For example, the driver gaze detection 142 can determine the gaze of the driver is directed to an angle or angular ranges relative to the DMC 132.

In some embodiments, gaze detection is performed by monitoring the head of the driver and determining orientation relative to the DMC 132. In some embodiments, gaze detection can be performed through monitoring the eyes of the driver, determining orientation relative to the head of the driver and/or relative to the DMC 132. In some embodiments, gaze detection can be performed by determining the geometry and location information associated with the surface of the cornea of the driver of the vehicle. In some embodiments, gaze detection can be performed using triangulation of the location information associated with the sensors, driver's eyes, and the infotainment system with respect to a local coordinate system.

External cameras 134 can be configured to capture image frames for environment detection 144 to detect the environment outside the vehicle. External cameras 134 can include forward-facing cameras. For example, forward-facing cameras include high-resolution main camera, wide-angle peripheral cameras, stereo vision pairs for depth perception. External cameras 134 can include side-mounted cameras. For example, side-mounted cameras include left and right view cameras, blind spot monitoring cameras, side mirror-integrated cameras. External cameras 134 can include rear-view cameras. For example, rear-view cameras include backup cameras, rear cross-traffic cameras, corner-mounted wide-angle cameras.

Portions of the external environment can be captured with radar 136. Radar 136 can include multiple radar sensors operating across different frequency bands and ranges for environment detection 144. Radar 136 can include short-range radar (SRR) units operating at 24 GHz or below 77 GHz, mid-range radar (MRR) units operating at 77 GHz, Long-range radar (LRR) units operating above 77 GHz. Radar 136 generates environment data including object distance through time-of-flight measurement, relative velocity through Doppler shift analysis, angular position through beam steering, object dimensions through radar cross-section analysis, material properties through signal reflection characteristics, location of the vehicle, speed and heading direction of the vehicle, detected objects in the environment (e.g., motorcycles, cyclists, pedestrians, road barriers, lane markers, road edges, dividers, and curbs, etc. Based on the environment data, radar 136 enables precise distance measurement, accurate velocity detection, object classification, movement prediction, collision risk assessment, etc.

Portions of the external environment can be captured with LIDAR 138. LIDAR 138 utilizes advanced optical sensing technology to create high-precision three-dimensional representations of the surrounding environment for environmental detection. LIDAR 138 includes LIDAR sensors incorporating solid-state laser emitters operating at wavelengths of 905 nm or 1550 nm, high-speed rotating mirror assemblies, photodetector arrays, precision timing circuits, beam steering mechanisms, etc. LIDAR 138 generates environment data including distance measurements, object dimensions and geometry, surface material characteristics, terrain topology, obstacle identification, gap detection, road structure mapping, etc.

Environment detection 144 enables continuous monitoring of static environmental elements such as road infrastructure, traffic signs and signals, lane markings, curbs and barriers, parked vehicles, building structures. Environment detection 144 also performs continuous monitoring of dynamic objects including moving vehicles, pedestrians, cyclists, animals, construction activities, emergency vehicles, etc.

It is understood other environmental detection techniques including ultrasonic proximity sensing may be used to generate environment data.

Fusion function 150 integrates data obtained from driver gaze detection 142 and environment detection 144 to provide enhanced object sensing and detection through complementary sensing modalities. Fusion function 150 transforms the coordinate of the data acquired via the driver gaze detection 142 and environment detection 144 to a common coordinate frame reference. In some embodiments, fusion function 150 can define a master coordinate system to include object detection data acquired by the driver gaze detection 142 and environment detection 144. Note that in some embodiments, the common coordinate reference frame is selected as the reference frame of the driver gaze detection 142 or environment detection 144 and fusion function 150 transforms the coordinates of the data to for the one that isn't selected to the common coordinate reference frame. Fusion function 150 can also perform temporal alignment (e.g., timestamp synchronization, buffer management, etc.) and spatial alignment (e.g., point cloud registration, feature matching, image registration, etc.) to align the object detection data acquired by the driver gaze detection 142 and environment detection 144. In some embodiments, fusion function 150 can employ a common object detection format, such as, bounding boxes to describe a spatial location of an object, object classes, confidence scores, etc.

In some embodiments, fusion function 150 determines, based on the gaze data and the environment model if a point of gaze of the driver intersects with the object within the environment model. For example, fusion function 150 identifies occurrences when the eye gaze of the driver overlaps with one or more detected objects in the environment data.

As illustrated in block 160, the fusion function 150 can determine if the driver is staring at an object while driving. For example, the fusion function 150 determines, based on the gaze data and the environment model, an initial time when a point of gaze of the driver intersects with the object within the environment model. The fusion function 150 determines, based on the initial time, a duration of a gaze time that the point of gaze of the driver intersects with the object. Based on the duration of gaze time, the fusion function 150 determines whether the duration of the gaze time is greater than a predefined threshold (e.g., 2 seconds). At block 160, if the fusion function 150 determines that the duration of the gaze time is not greater than the predefined threshold, the fusion function 150 does not perform a subsequent action (block 162). For example, in some embodiments, if he driver is looking at an object for 70% of the time in the past 4 s, then the fusion function 150 treats that as staring the object or being concerned about the object.

If the fusion function 150 determines that the duration of the gaze time is greater than the predefined threshold, the fusion function 150 determines the driver data indicates the driver performs a valid gesture (block 170) based on the gesture data obtained from driver gesture detection 140. For example, the fusion function 150 can detect and interpret valid hand gestures such as wave-through gestures and stop/wait gestures. The fusion function 150 can interpret palm-forward hand raise, horizontal waving motion, beckoning hand movement, directional pointing as wave-through gestures. The fusion function 150 can interpret stop/wait gestures such as raised palm facing pedestrian, horizontal hand hold, downward palm motion, time-indicating finger gesture.

In some embodiments, the fusion function 150 can also recognize head gestures such as yielding gestures and acknowledgement gestures. The fusion function 150 interprets head tilt with eye contact, combined head nod with hand signal, sustained attention indication as yielding gestures. The fusion function 150 interprets a deliberate head nod, and a single head bow as acknowledgment gestures.

In some embodiments, the fusion function 150 also correlates contexts (e.g., environmental factors and vehicle status) for determining the hand gesture of the driver. For example, environmental factors can include one or more of the presence of pedestrian, crosswalk proximity, traffic conditions, time of day, etc. The fusion function also considers vehicle status such as speed, distance to pedestrian, braking status, turn signals for determining the hand gesture of the driver.

In some embodiments, the fusion function 150 determines the driver performs a valid hand gesture if the driver maintains one hand on the steering wheel to ensure safety operating of the vehicle. In some other embodiments, the fusion function 150 determines the driver perform a valid hand gesture if the driver maintains a forward attention. In some other embodiments, the fusion function 150 determines the driver performs a valid hand gesture if the hand gesture is clearly visible, culturally appropriate, and unambiguous.

The fusion function 150 can also recognize specific driver body postures and movements for pedestrian communication. In some embodiments, the fusion function 150 can determine that forward lean gestures indicate attention and acknowledgment. For example, the fusion function 150 determines the driver is indicating attention and acknowledgement when the fusion function 150 detects a body gesture such as an intentional forward torso movement, a predefined controlled lean angle (e.g., 15-30 degrees) maintained for a duration of 1-3 seconds while the driver is making an eye contact with another person, etc. The fusion function 150 can determine lateral body movements to indicate a directional intent and confirm object (e.g., pedestrian) awareness. In some embodiments, the fusion function 150 determines the driver is indicating a directional intent and confirm object (e.g., pedestrian) awareness when the fusion function 150 detects a body gesture such as side-to-side visible shifts, shoulder orientation changes, head-body alignment, etc.

At block 170, if the fusion function 150 determines a valid gesture of the driver based on the gesture data upon determining the duration of the gaze time is greater than the predefined threshold, the fusion function 150 transmits parameters 180 to the ADAS 100. For example, the fusion function 150 transmits object identification (ID) of the detected object determined at block 160 to the ADAS 100 for appropriate actions by automative component system in the ADAS 100. The fusion function 150 can also transmits the gaze time and gesture type information as determined at block 170 to the ADAS 100 for appropriate actions by the automative component system. For example, based on the object ID, gaze time, and gesture type, the automative component system activates a speed adjustment function (e.g., to reduce the vehicle's speed, etc.), regenerative braking level (e.g., to increase or decrease the braking level, etc.), coasting mode activation (e.g., to activate or deactivate the coasting of the vehicle, etc.), gentle acceleration mode (e.g., to have the vehicle accelerate gently, etc.), creep function control (e.g., to have the vehicle creep, etc.), etc.

At block 170, if the fusion function 150 determines an invalid gesture of the driver based on the gesture data upon determining the duration of the gaze time is greater than the predefined threshold, the fusion function 150 transmits parameters (e.g., gaze time and object ID of the detected object) to the ADAS 100 (block 172).

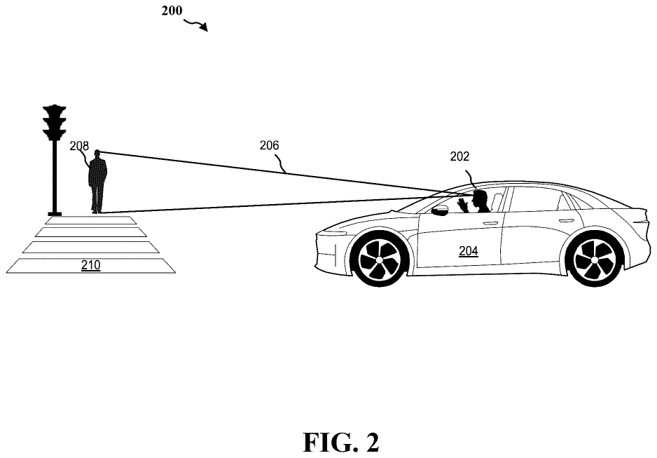

FIG. 2 illustrates a scenario 200 in which the embodiments as described in FIG. 1 can be implemented, in accordance with some embodiments. In some embodiments, the scenario 200 can include a driver 202 operating a vehicle 204 in an urban environment. As illustrated, the vehicle 204 is approaching an intersection and a pedestrian 208 is about to enter the pedestrian crosswalk 210. The ADAS 100 detects that the driver 202 is staring at the pedestrian 208 and waving at the pedestrian 208 to enter the pedestrian crosswalk 210. In response, the ADAS 100 activates deceleration function of the vehicle 204 causing a speed of the vehicle 204 to decrease. The ADAS 100 can wait for the pedestrian 208 to complete the crossing of the pedestrian crosswalk 210 before activating the acceleration function to cause the speed of the vehicle 204 to increase. Embodiments can reliably predict pedestrian prediction, maintain safe distance, recognize the intent of the driver, etc.

With reference to FIGS. 1 and 2, in some embodiments, driver gaze detection 142 uses the gaze data of the driver 202 and the environment data to cause the driver assistance control to be activated. For example, driver gaze detection 142 transforms the output vectors and eye location from the DMC coordinate system to the environment model coordinate system. This allows driver gaze detection 142 to project a point of gaze 206 of the driver 202 to the environment data and determines if the point of gaze 206 of the driver 202 intersects with objects in the environment model.

In some embodiments, the driver gaze detection 142 can determine, based on the gaze data and the environment model, an initial time when a point of gaze 206 of the driver intersects with an object within the environment model. The driver gaze detection 142 can determine based on the initial time, a duration of a gaze time that the point of gaze 206 of the driver intersects with the object. The driver gaze detection 142 can determine whether the duration of the gaze time is greater than a predefined threshold. For example, the driver gaze detection 142 determines the driver 202 of the vehicle is staring at a pedestrian 208 when the system determines the duration of gaze time is greater than 2-3 seconds. Alternatively, in some other embodiments, the driver gaze detection 142 determines the driver 202 of the vehicle is staring at a pedestrian 208 when the system determines the duration of gaze time is greater than seventy percent of the last 4 seconds. Note that other durations and/or measures can be used as well.

In some embodiments, responsive to determining that the duration of the gaze time is greater than the predefined threshold, the fusion function 150 can determine a target distance between the vehicle 204 and the object (e.g., pedestrian 208). The ADAS can adjust, via the driver assistance control, a speed of the vehicle based on the target distance. For example, when the fusion function 150 determines the driver 202 of the vehicle 204 is staring at an object (e.g., pedestrian 208), the fusion function 150 can determine parameters (e.g., distance between the object and the vehicle 204, relative velocity, direction of movement, size, and dimensions, etc.) associated with the object and slow or stop the vehicle upon determining that those parameters and a driver gesture indicating that the driver's intent is to let the object (e.g., pedestrian 208) cross in front of the vehicle.

In some embodiments, the fusion function 150 determines and/or accesses parameters (e.g., present speed, acceleration/deceleration capability, vehicle mass and momentum, road gradient, surface conditions, etc.) associated with the vehicle 204 to calculate an optimal speed adjustment. In some embodiments, the fusion function 150 also determines the required speed changes based on the time-to-collision calculations, safe following distance requirements, minimum stopping distance, posted speed limits, weather conditions, etc. The fusion function 150 can adjust the speed of the vehicle through a gradual deceleration profile. For example, the fusion function 150 can apply an initial gentle braking, progressively increase braking force, or performs a smooth transition to a target speed. While the fusion function 150 adjusts the speed, the fusion function 150 continuously monitors the object's dynamic behavior, relative distance between the object and the vehicle, driver override inputs, etc. The fusion function 150 can maintain constant safe distance monitoring until the object is no longer in vehicle's path, a safe distance is established, the driver assumes manual control, etc.

In some embodiments, the fusion function 150 detects, based on gaze data, that the point of gaze 206 intersects with the object. For example, the driver 202 of the vehicle is staring at a pedestrian 208 for a predefined duration of time. The fusion function 150 can determine, based on the sensor data, that the pedestrian 208 is not present within a predefined crossing zone. For example, the radar sensors of the vehicle 204 do not detect a pedestrian within the pedestrian crossing zone. Based on the radar sensors output, the fusion function 150 determines that there is no pedestrian in the vehicle's path. Therefore, the fusion function 150 determines that the pedestrian has not entered the pedestrian crossing zone.

The fusion function 150 can determine that a duration of time associated with the object completing a crossing of the predefined crossing zone is greater than a predefined crossing time. For example, the fusion function 150 maintains a database of road user behavior patterns, such as, for example, pedestrian baseline crossing time, pedestrian baseline wait time, etc. When the fusion function 150 determines that the pedestrian did not enter the pedestrian crossing zone, the fusion function 150 can progressively increase, via the driver assistance control, a speed of the vehicle at a predefined increment.

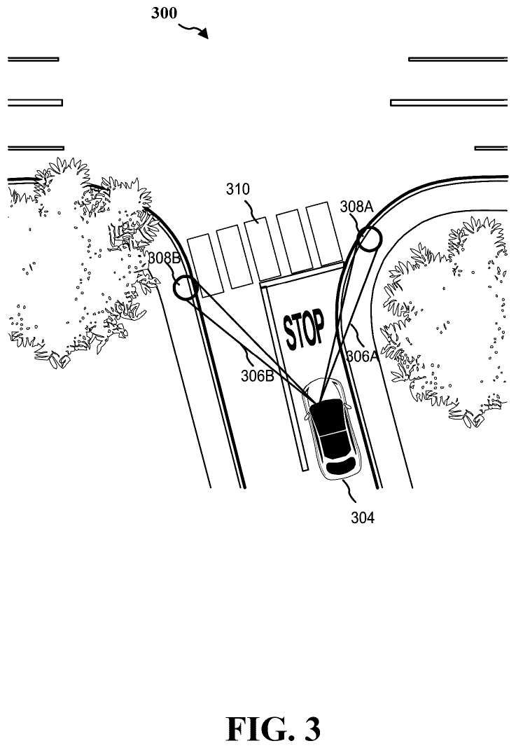

FIG. 3 illustrates a scenario 300 in which the embodiments of the present disclosure can be implemented, in accordance with some embodiments. In some embodiments, the fusion function 150 can detect, based on the gesture data, the gesture of the driver is the hand gesture to enter the predefined crossing zone while the point of gaze of the driver intersects with the object within the environment model. For example, referring to FIG. 3, the point of gaze 306A of the driver of the vehicle 304 intersects with the pedestrian 308A at a first time. While maintaining the gaze at the pedestrian 308A, the driver of the vehicle 304 performs a hand gesture (e.g., raises palm facing the pedestrian 308A, index finger or whole hand points in the crosswalk direction) indicating to the pedestrian 308A to enter the pedestrian crosswalk zone. In another example, while maintaining the gaze at the pedestrian 308A, the driver of the vehicle 304 inwardly sweeps the hand paired with a head nod or verbal cues to signal the pedestrian 308A to enter the pedestrian crosswalk zone. It is understood other known hand gestures combined with body gestures and verbal cues may be used to interact with the pedestrian 308A at the pedestrian crosswalk zone.

In some embodiments, the fusion function 150 can detect, based on the gaze data and the environment model, that the point of gaze intersects with the object outside of the predefined crossing zone. The fusion detects, based on the gesture data, the hand gesture including at least one of: a palm-forward hand raise, or a horizontal sweeping motion, the hand gesture indicating a confirmation that the object is not present within the predefined crossing zone. For example, referring to FIG. 3, after the pedestrian 308B completes the crossing of the pedestrian crosswalk zone, the driver of the vehicle moves the point of gaze 306B towards the pedestrian 308B. While the point of gaze 306B intersects with the pedestrian 308A, the driver of the vehicle 304 raises the palm facing-out towards the pedestrian 308B indicating the pedestrian 308B completes the crossing of the pedestrian crosswalk zone. In another example, the driver of the vehicle 304 raises the hand with side-to-side movements accompanied by a head nod.

In some embodiments, the fusion function 150 can detect a speed of the vehicle equals to zero and detects the hand gesture of the driver. The fusion function 150 determines, based on the sensor data, that the object is not present within the predefined crossing zone. For example, referring to FIG. 3, the driver of the vehicle 304 performs a hand gesture towards the pedestrian 308A after the vehicle 304 has come to a complete stop at the intersection, the vehicle 304 will not move until the pedestrian 308A has completed the crossing of the pedestrian crosswalk zone 310.

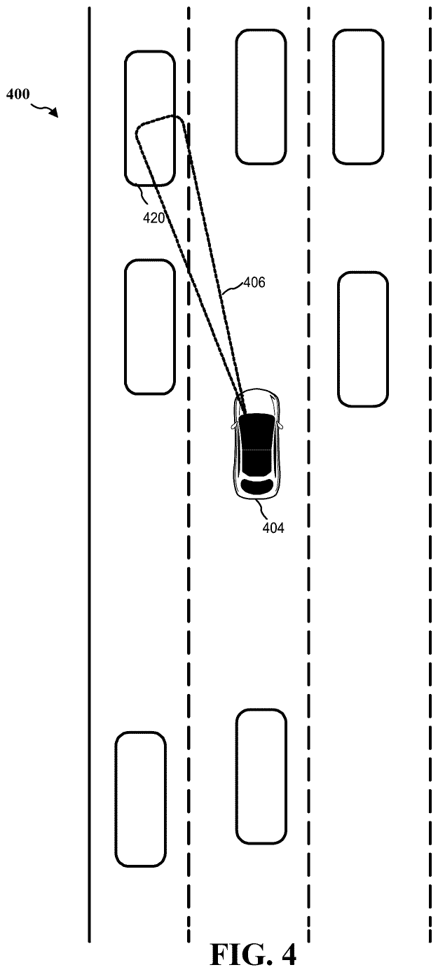

FIG. 4 illustrates a scenario 400 in which the embodiments of the present disclosure can be implemented, in accordance with some embodiments. The fusion function 150 can detect a presence of the object within a predefined zone surrounding the vehicle. The fusion function 150 can detect, based on gaze data, that the duration of time that the point of gaze intersects with the object. The fusion function 150 can determine whether the duration is greater than a predefined threshold. The fusion function 150 can maneuver, via the driver assistance control, the vehicle away from the object, such that a separation distance separating the vehicle and the object is at least a predefined separation distance. For example, referring to FIG. 4, the driver of the vehicle 404 engages an adaptive cruise control and lane centering active features while driving in a freeway. While driving, the point of gaze 406 of the driver intersects with an object (e.g., another vehicle 420) in an adjacent lane. In other words, while driving, the driver of the vehicle 404 keeps staring at another vehicle 420 in the adjacent lane. In response to receiving these inputs, the fusion function 150 signals the ADAS to navigate the vehicle 404 laterally to bias away from the other vehicle 420 such that the vehicle 404 maintains a safe separation distance.

In some embodiments, the fusion function 150 calculates a safe separation distance using the following equation:

Bias=W1*Bias1+W2*Bias2+ . . . +Wn*Biasn, where Wn is a weighted factor and Biasn is an n-th bias

where n represents the number of vehicles or reasons to bias. In some embodiments, the fusion function 150 can detect that the object deviates from a predefined safe driving pattern. The fusion function 150 can determine, based on the environment model, a presence of nearby objects within a predefined lane changing zone before initiating a lane change. The fusion function 150 initiates, via the driver assistance control, the lane change for the vehicle towards the predefined lane changing zone and away from the object. For example, referring to FIG. 4, the driver of the vehicle 404 determines the other vehicle 420 is exhibiting an unstable driving behavior (e.g., weaving side to side within or across lanes, periodic lateral movement, inconsistent position within lane, repeated correction movements, drifting gradually to one side, crossing lane markers repeatedly, regular left-right swaying motion, etc.) due to the driver condition or vehicle mechanical issue. In response, the fusion function 150 determines the oscillating behavior is a warning sign requiring an immediate attention. Therefore, the fusion function 150 signals the ADAS 100 to initiate a lane change to keep a safe distance away from the other vehicle 420.

In the above examples, the fusion function 150 determines the intent of the driver using the captured eye gazing data and the gesture recognition of captured driver data and its able to control the vehicle based on the combination of those inputs.

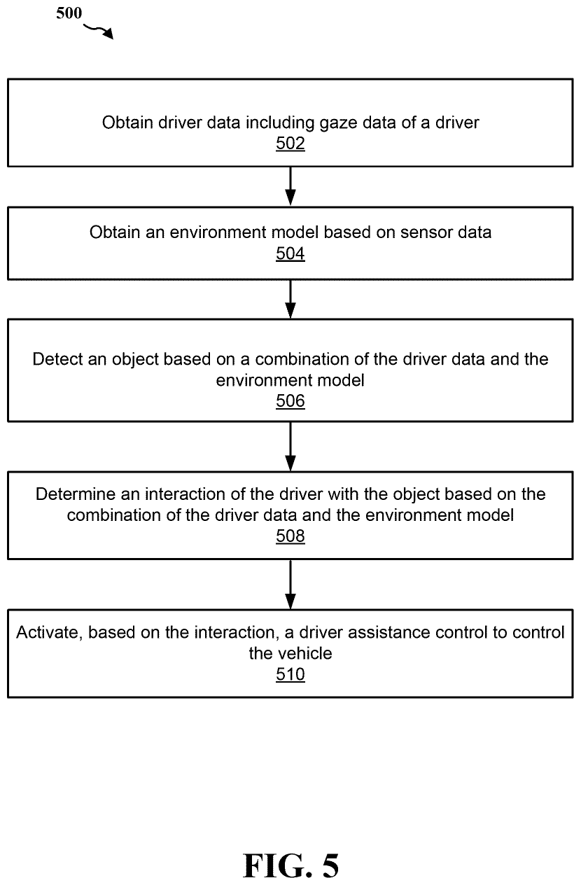

FIG. 5 is a data flow diagram of some embodiments of a method for controlling a vehicle via a driver assistance control in accordance with some embodiments. The method may be performed by processing logic that may comprise hardware (e.g., circuitry, dedicated logic, programmable logic, a processor, a processing device, a CPU, a system-on-chip, etc.), software (e.g., instructions running/executing on a processing device), firmware (e.g., microcode), or a combination thereof. In some embodiments, at least a portion of the method may be performed based on aspects of FIGS. 1-4.

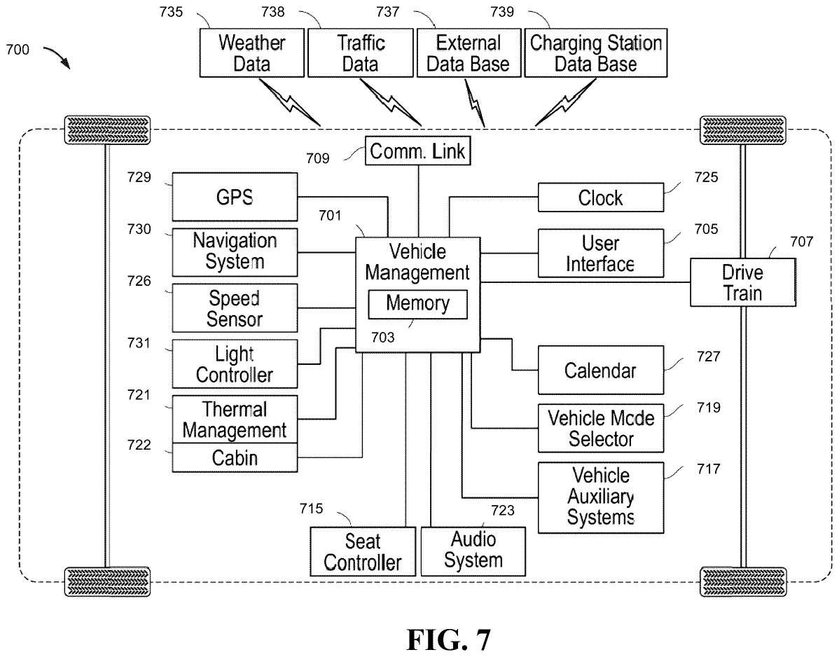

With reference to FIG. 7, the method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

The method begins at block 502, where processing logic can obtain driver data including gaze data of a driver. For example, referring to FIG. 1, the fusion function can obtain driver data including gaze data of the driver using the DMC 132, as described above.

As also shown in FIG. 5, at block 504, processing logic can obtain an environment model based on sensor data. For example, referring to FIG. 1, fusion function 150 can obtain environment model generated based on external cameras 134, radar 136, LIDAR 138, as described above. In some embodiments, the environment model depicts the environment, or portion thereof, outside of the vehicle.

As further shown in FIG. 5, at block 506, processing logic can detect an object based on a combination of the driver data and the environment model. For example, referring to FIG. 1, fusion function 150 detect an object based on determining that the point of gaze of the driver intersects the object. The fusion function 150 determines that the driver of the vehicle is staring at the object if the gaze time exceed s predefined threshold, as described above.

As additionally shown in FIG. 5, at block 508, processing logic can determine an interaction of the driver with the object based on the combination of the driver data and the environment model. For example, referring to FIG. 3, while maintaining the driver point of gaze 306A at the pedestrian 308A, the driver of the vehicle 304 performs a hand gesture indicating the pedestrian 308A to enter the pedestrian crosswalk zone, as described above. As a result, the fusion function 150 can understand the intent of the driver based on the eye gaze data, gesture data, and the environment model.

As furthermore shown in FIG. 5, at block 510, processing logic can activate, based on the interaction, a driver assistance control to control the vehicle. Referring to FIG. 5, for example, the fusion function 150 can adjust, via the driver assistance control, a speed of the vehicle based on the determination of the interaction of the driver with an object, without the need for the driver to apply force on the brake pedal or use the voice command, as described above. Other automotive functions can be activated and/or deactivated based on the driver's interaction with the object.

Although FIG. 5 shows example blocks of data flow diagram 500, in some implementations, data flow diagram 500 may include additional blocks, fewer blocks, different blocks, or differently arranged blocks than those depicted in FIG. 5. Additionally, or alternatively, two or more of the blocks of data flow diagram 500 may be performed in parallel.

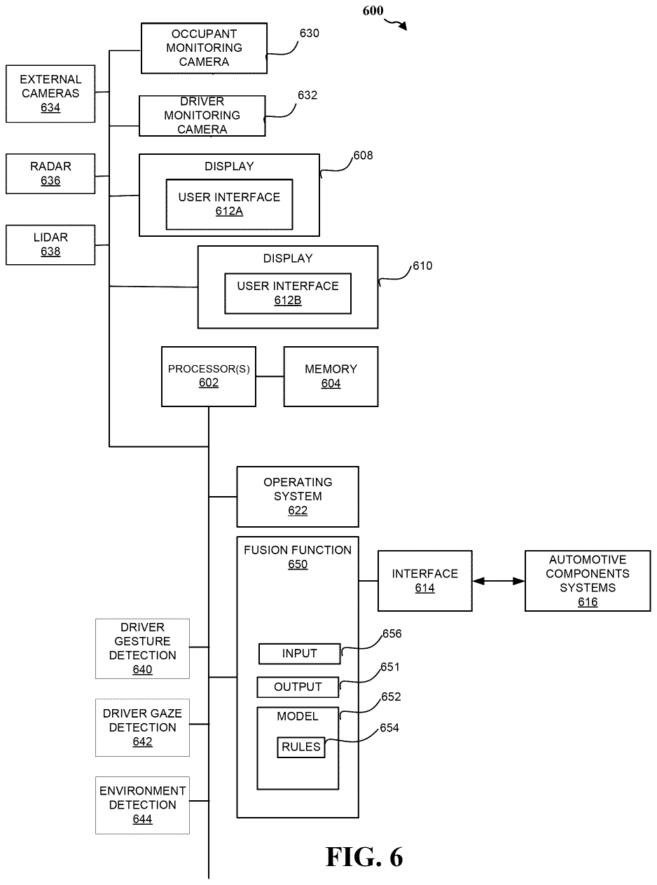

FIG. 6 is a block diagram 600 illustrating some embodiments of a gaze detection system in accordance with some embodiments. One or more processors 602 coupled to memory 604 perform processing duties according to various software, hardware, firmware, or combination modules. The processor(s) 602 and memory 604 are coupled to an occupant monitoring camera 630, a driver monitoring camera 632, external cameras 634, radar 636, LIDAR 638, a first display 608 (e.g., having a display screen) on which a user interface 612A is displayed, a second display 610 on which a user interface 612B is displayed. Also, the processor(s) 602 and memory 604 are coupled to an operating system 622, a driver gesture detection 640, driver gaze detection 642, environment detection 644, and a fusion function 650. The fusion function 650 has an input module 656, and output module 651, and in some embodiments includes a model 652 with rules 654. Other forms of models may be used in some embodiments. The fusion function 650 can be coupled to an interface 614 which can be coupled to automotive components and systems 616 in order to control, adjust or otherwise provide input to such components and systems. Automotive components and systems 616 can include cruise control operations, speed adjustment, following distance modification, speed limiting functions, stopping functions, parking operations, vehicle motion control, etc. One form of implementation is special programming of the system, more specifically special programming of the processor(s) 602. It should be appreciated that structure of the various modules is determined by their functionality, in some embodiments.

In an operating scenario, which describes functionality of some embodiments, a driver or occupant of a vehicle is imaged by the occupant monitoring camera 630 and the driver monitoring camera 632. Using the environment detection 644, the system generated environment model including detected objects such as cars, motorcycles, cyclists, pedestrians, road barriers, lane markers, road edges, dividers, and curbs. Using the driver gaze detection 642, the system determines what the driver is gazing at and the duration of the gaze time. In some embodiments, the system uses the driver gesture detection 640 to determine the gesture performed by the driver, as described above. The determined gaze information is passed along through the input module 656 of the fusion function 650, along with the environment model and the determined gesture information.

The fusion function 650 determines an intent and also an interaction of the driver with the object based on the combination of the determined gaze information, the environment model, and the determined gesture information. The system can adjust, via the driver assistance control, a speed of the vehicle based on the determination of the intent and the interaction of the driver with the object, without the need for the driver to apply force on the brake pedal or use the voice command, as described above.

All of the above is coordinated through the operating system 622, which may be a real-time operating system. It should be appreciated that the fusion function 150 may be integrated with or part of the operating system 622, in some embodiments.

FIG. 7 is a high-level view of some embodiments of a vehicle 700. Vehicle 700 can be an electric vehicle (EV), a vehicle utilizing an internal combustion engine (ICE), or a hybrid vehicle, where a hybrid vehicle utilizes multiple sources of propulsion including an electric drive system. Vehicle 700 includes vehicle management 701 which is comprised of a processor (e.g., a central processing unit (CPU)). The vehicle management 701 also includes memory 703, with memory 703 being comprised of EPROM, EEPROM, flash memory, RAM, solid state drive, hard disk drive, or any other type of memory or combination of memory types. It should be understood that the terms “vehicle management system,” “system controller” and “vehicle on-board system controller” can be used interchangeably throughout this disclosure. A user interface 705 is coupled to the vehicle management 701. User interface 705 allows the driver, or a passenger, to interact with the vehicle management system, for example inputting data into the navigation system 730, altering the heating, ventilation and air conditioning (HVAC) system via the thermal management system 721, controlling the vehicle's entertainment system (e.g., radio, CD/DVD player, etc.), adjusting vehicle settings (e.g., seat positions, light controls, etc.), and/or otherwise altering the functionality of vehicle 700. In at least some embodiments, user interface 705 also includes means for the vehicle management system to provide information to the driver and/or passenger, information such as a navigation map or driving instructions (e.g., via the navigation system 730 and GPS system 729) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 726), current HVAC settings such as cabin temperature and/or fan settings, etc.) via the thermal management system 721. User interface 705 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 700 can also include other features like an internal clock 725 and a calendar 727.

In some embodiments, user interface 705 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 705 includes a graphical display, the vehicle management 701 may also include a graphical processing unit (GPU), with the GPU being either separate from or contained on the same chip set as the processor.

Vehicle 700 also includes a drive train 707 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip).

Drivers often alter various vehicle settings, either when they first enter the car or while driving, in order to vary the car to match their physical characteristics, their driving style and/or their environmental preferences. The vehicle management 701 monitors various vehicle functions that the driver may use to enhance the fit of the car to their own physical characteristics, such as seat position (e.g., seat position, seat height, seatback incline, lumbar support, seat cushion angle and seat cushion length) using seat controller 715 and steering wheel position using an auxiliary vehicle system controller 717. In some embodiments, the vehicle management 701 also can monitor a driving mode selector 719 which is used to control performance characteristics of the vehicle (e.g., economy, sport, normal). In some embodiments, the vehicle management 701 can also monitor suspension characteristics using auxiliary vehicle system controller 717, assuming that the suspension is user adjustable. In some embodiments, the vehicle management 701 also monitors those aspects of the vehicle which are often varied by the user in order to match his or her environmental preferences for the cabin 722, for example setting the thermostat temperature or the recirculation controls of the thermal management system 721 that uses an HVAC controller, and/or setting the radio station/volume level of the audio system using controller 723, and/or setting the lights, either internal lighting or external lighting, using light controller 731. Also, besides using user-input and on-board sensors, the vehicle management 701 can also use data received from an external on-line source that is coupled to the controller via communication link 709 (using, for example, GSM, EDGE, UMTS, CDMA, DECT, WiFi, WiMax, etc.). For example, in some embodiments, the vehicle management 701 can receive weather information using an on-line weather service 735 or an on-line data base 737, traffic data 738 for traffic conditions for the navigation system 730, charging station locations from a charging station database 739, etc.

As an example, upon turning on the vehicle 700, in some embodiments, the vehicle management 701 identifies the current driver (and go to their last pre-set functions) or just go the last pre-set functions for the vehicle (independent of who the current driver is), related to such features as: media functions, climate functions-heating, ventilation and air conditioning (HVAC) system, driving functions, seat positioning, steering wheel positioning, light control (e.g., internal lighting, external lighting, etc.), navigation functions, etc. Note that for purposes herein, the techniques will be described with reference to capacitive controllers. Even so, the techniques are not limited to the capacitive controllers and can be employed with other types of controllers.

There are a number of example embodiments described herein.

Example 1 is a method of controlling a vehicle via a driver assistance control, where the method includes: obtaining driver data including gaze data of a driver obtaining an environment model based on sensor data; detecting an object based on a combination of the driver data and the environment model; determining an interaction of the driver with the object based on the combination of the driver data and the environment model; and activating, based on the interaction, a driver assistance control to control the vehicle.

Example 2 is the method of example 1 that may optionally include that determining the interaction of the driver with the object includes: determining, based on the gaze data and the environment model, an initial time when a point of gaze of the driver intersects with the object within the environment model; determining, based on the initial time, a duration of a gaze time that the point of gaze of the driver intersects with the object; and determining whether the duration of the gaze time is greater than a predefined threshold.

Example 3 is the method of example 2 that may optionally include, responsive to determining that the duration of the gaze time is greater than the predefined threshold, determining a target distance between the vehicle and the object and adjusting, via the driver assistance control, a speed of the vehicle based on the target distance.

Example 4 is the method of example 1 that may optionally include detecting, based on gaze data, that the point of gaze intersects with the object; determining, based on the sensor data, that the object is not present within a predefined crossing zone; determining that a duration of time associated with the object completing a crossing of the predefined crossing zone is greater than a predefined crossing time; and increasing, via the driver assistance control, a speed of the vehicle at a predefined increment.

Example 5 is the method of example 3 that may optionally include that the driver data comprises gesture data, further comprising: determining a gesture of the driver based on the gesture data upon determining the duration of the gaze time is greater than the predefined threshold, and wherein the gesture of the driver includes: a hand gesture, a head gesture, or a body gesture.

Example 6 is the method of example 5 that may optionally include that the object includes at least one of: a pedestrian, a cyclist, or another vehicle, and wherein determining the interaction of the driver with the object further comprising: detecting, based on the gesture data, the gesture of the driver is the hand gesture to enter a predefined crossing zone while the point of gaze of the driver intersects with the object within the environment model.

Example 7 is the method of example 6 that may optionally include that detecting, based on the gaze data and the environment model, that the point of gaze intersects with the object outside of the predefined crossing zone; and detecting, based on the gesture data, the hand gesture including at least one of: a palm-forward hand raise or a horizontal waving motion, the hand gesture indicating a confirmation that the object is not present within the predefined crossing zone.

Example 8 is the method of example 7 that may optionally include detecting a speed of the vehicle equals to zero; detecting the hand gesture of the driver; and determining, based on the sensor data, that the object is not present within the predefined crossing zone.

Example 9 is the method of example 8 that may optionally include detecting a presence of the object within a predefined zone surrounding the vehicle; detecting, based on gaze data, that the duration of time that the point of gaze intersects with the object; determining whether the duration is greater than a predefined threshold; and maneuvering, via the driver assistance control, the vehicle away from the object, such that a separation distance separating the vehicle and the object is at least a predefined separation distance.

Example 10 is the method of example 9 that may optionally include detecting that the object deviates from a predefined safe driving pattern; determining, based on the environment model, a presence of nearby objects within a predefined lane changing zone before initiating a lane change; and initiating, via the driver assistance control, the lane change for the vehicle towards the predefined lane changing zone and away from the object.

Example 11 is a vehicle control system that includes a processor and a memory coupled to the processor to store instructions, which when executed by the processor, cause the processor to perform operations. The operations include: obtaining driver data including gaze data of a driver; obtaining an environment model based on sensor data; detecting an object based on a combination of the driver data and the environment model; determining an interaction of the driver with the object based on the combination of the driver data and the environment model; and activating, based on the interaction, a driver assistance control to control the vehicle.

Example 12 is the method of example 11 that may optionally include that determining the interaction of the driver with the object includes: determining, based on the gaze data and the environment model, an initial time when a point of gaze of the driver intersects with the object within the environment model; determining, based on the initial time, a duration of a gaze time that the point of gaze of the driver intersects with the object; and determining whether the duration of the gaze time is greater than a predefined threshold.

Example 13 is the method of example 12 that may optionally include, responsive to determining that the duration of the gaze time is greater than the predefined threshold, determining a target distance between the vehicle and the object; and adjusting, via the driver assistance control, a speed of the vehicle based on the target distance.

Example 14 is the method of example 12 that may optionally include detecting, based on gaze data, that the point of gaze intersects with the object; determining, based on the sensor data, that the object is not present within a predefined crossing zone; determining that a duration of time associated with the object completing a crossing of the predefined crossing zone is greater than a predefined crossing time; and increasing, via the driver assistance control, a speed of the vehicle at a predefined increment.

Example 15 is the method of example 13 that may optionally include that the driver data comprises gesture data, and the method further includes: determining a gesture of the driver based on the gesture data upon determining the duration of the gaze time is greater than the predefined threshold, and wherein the gesture of the driver includes: a hand gesture, a head gesture, or a body gesture.

Example 16 is the method of example 15 that may optionally include that the object includes at least one of: a pedestrian, a cyclist, or another vehicle, and wherein determining the interaction of the driver with the object further comprising: detecting, based on the gesture data, the gesture of the driver is the hand gesture to enter a predefined crossing zone while the point of gaze of the driver intersects with the object within the environment model.

Example 17 is the method of example 16 that may optionally include detecting, based on the gaze data and the environment model, that the point of gaze intersects with the object outside of the predefined crossing zone; and detecting, based on the gesture data, the hand gesture including at least one of: a palm-forward hand raise or a horizontal waving motion, the hand gesture indicating a confirmation that the object is not present within the predefined crossing zone.

Example 18 is the method of example 17 that may optionally include detecting a speed of the vehicle equals to zero; detecting the hand gesture of the driver; and determining, based on the sensor data, that the object is not present within the predefined crossing zone.

Example 19 is the method of example 18 that may optionally include detecting a presence of the object within a predefined zone surrounding the vehicle; detecting, based on gaze data, that the duration of time that the point of gaze intersects with the object; determining whether the duration is greater than a predefined threshold; and maneuvering, via the driver assistance control, the vehicle away from the object, such that a separation distance separating the vehicle and the object is at least a predefined separation distance.

Example 20 is a non-transitory machine-readable storage medium having instructions stored therein, which when executed by a processor, cause the processor to perform operations, where the operations include: obtaining driver data including gaze data of a driver; obtaining an environment model based on sensor data; detecting an object based on a combination of the driver data and the environment model; determining an interaction of the driver with the object based on the combination of the driver data and the environment model; and activating, based on the interaction, a driver assistance control to control a vehicle.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent, or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer, or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In some embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

1. A method of controlling a vehicle via a driver assistance control, the method being performed by a processor coupled to a gaze sensor and an environment sensor system, the method comprising:
obtaining driver data including gaze data of a driver;
obtaining an environment model based on sensor data;
detecting an object based on a combination of the driver data and the environment model, wherein detecting the object comprises determining, based on the gaze data and the environment model, that a point of gaze of the driver intersects with the object within the environment model;
determining an interaction of the driver with the object based on the combination of the driver data and the environment model; and
activating, based on the interaction, a driver assistance control to control the vehicle.

2. The method of claim 1, wherein the determining the interaction of the driver with the object comprises:
determining, based on the gaze data and the environment model, an initial time when a point of gaze of the driver intersects with the object within the environment model;
determining, based on the initial time, a duration of a gaze time that the point of gaze of the driver intersects with the object; and
determining whether the duration of the gaze time is greater than a predefined threshold.

3. The method of claim 2, further comprising:
responsive to determining that the duration of the gaze time is greater than the predefined threshold, determining a target distance between the vehicle and the object; and
adjusting, via the driver assistance control, a speed of the vehicle based on the target distance.

4. The method of claim 2, further comprising:
detecting, based on gaze data, that the point of gaze intersects with the object;
determining, based on the sensor data, that the object is not present within a predefined crossing zone;
determining that a duration of time associated with the object completing a crossing of the predefined crossing zone is greater than a predefined crossing time; and
increasing, via the driver assistance control, a speed of the vehicle at a predefined increment.

5. The method of claim 3, wherein the driver data comprises gesture data, further comprising:
determining a gesture of the driver based on the gesture data upon determining the duration of the gaze time is greater than the predefined threshold, and
wherein the gesture of the driver includes:
a hand gesture,
a head gesture, or
a body gesture.

6. The method of claim 5, wherein the object includes at least one of:
a pedestrian,
a cyclist, or
another vehicle, and
the determining the interaction of the driver with the object further comprising:
detecting, based on the gesture data, the gesture of the driver is the hand gesture to enter a predefined crossing zone while the point of gaze of the driver intersects with the object within the environment model.

7. The method of claim 6, further comprising:
detecting, based on the gaze data and the environment model, that the point of gaze intersects with the object outside of the predefined crossing zone; and
detecting, based on the gesture data, the hand gesture including at least one of: a palm-forward hand raise or a horizontal waving motion, the hand gesture indicating a confirmation that the object is not present within the predefined crossing zone.

8. The method of claim 7, further comprising:
detecting a speed of the vehicle equals to zero;
detecting the hand gesture of the driver; and
determining, based on the sensor data, that the object is not present within the predefined crossing zone.

9. The method of claim 8, further comprising:
detecting a presence of the object within a predefined zone surrounding the vehicle;
detecting, based on gaze data, that the duration of time that the point of gaze intersects with the object;
determining whether the duration is greater than a predefined threshold; and
maneuvering, via the driver assistance control, the vehicle away from the object, such that a separation distance separating the vehicle and the object is at least a predefined separation distance.

10. The method of claim 9, further comprising:
detecting that the object deviates from a predefined safe driving pattern;
determining, based on the environment model, a presence of nearby objects within a predefined lane changing zone before initiating a lane change; and
initiating, via the driver assistance control, the lane change for the vehicle towards the predefined lane changing zone and away from the object.

11. A vehicle control system, comprising:
a processor,
a memory coupled to the processor to store instructions, which when executed by the processor, cause the processor to perform operations, the operations comprising:
obtaining driver data including gaze data of a driver;
obtaining an environment model based on sensor data;
detecting an object based on a combination of the driver data and the environment model, wherein detecting the object comprises determining, based on the gaze data and the environment model, that a point of gaze of the driver intersects with the object within the environment model;
determining an interaction of the driver with the object based on the combination of the driver data and the environment model; and
activating, based on the interaction, a driver assistance control to control the vehicle.

12. The system of claim 11, wherein the determining the interaction of the driver with the object comprises:
determining, based on the gaze data and the environment model, an initial time when a point of gaze of the driver intersects with the object within the environment model;
determining, based on the initial time, a duration of a gaze time that the point of gaze of the driver intersects with the object; and
determining whether the duration of the gaze time is greater than a predefined threshold.

13. The system of claim 12, further comprising:
responsive to determining that the duration of the gaze time is greater than the predefined threshold, determining a target distance between the vehicle and the object; and
adjusting, via the driver assistance control, a speed of the vehicle based on the target distance.

14. The system of claim 12, further comprising:
detecting, based on gaze data, that the point of gaze intersects with the object;
determining, based on the sensor data, that the object is not present within a predefined crossing zone;
determining that a duration of time associated with the object completing a crossing of the predefined crossing zone is greater than a predefined crossing time; and
increasing, via the driver assistance control, a speed of the vehicle at a predefined increment.

15. The system of claim 13, wherein the driver data comprises gesture data, further comprising:
determining a gesture of the driver based on the gesture data upon determining the duration of the gaze time is greater than the predefined threshold, and
wherein the gesture of the driver includes:
a hand gesture,
a head gesture, or
a body gesture.

16. The system of claim 15, wherein the object includes at least one of:
a pedestrian,
a cyclist, or
another vehicle, and
the determining the interaction of the driver with the object further comprising:
detecting, based on the gesture data, the gesture of the driver is the hand gesture to enter a predefined crossing zone while the point of gaze of the driver intersects with the object within the environment model.

17. The system of claim 16, further comprising:
detecting, based on the gaze data and the environment model, that the point of gaze intersects with the object outside of the predefined crossing zone; and
detecting, based on the gesture data, the hand gesture including at least one of: a palm-forward hand raise or a horizontal waving motion, the hand gesture indicating a confirmation that the object is not present within the predefined crossing zone.

18. The system of claim 17, further comprising:
detecting a speed of the vehicle equals to zero;
detecting the hand gesture of the driver; and
determining, based on the sensor data, that the object is not present within the predefined crossing zone.

19. The system of claim 18, further comprising:
detecting a presence of the object within a predefined zone surrounding the vehicle;
detecting, based on gaze data, that the duration of time that the point of gaze intersects with the object;
determining whether the duration is greater than a predefined threshold; and
maneuvering, via the driver assistance control, the vehicle away from the object, such that a separation distance separating the vehicle and the object is at least a predefined separation distance.

20. A non-transitory machine-readable storage medium having instructions stored therein, which when executed by a processor, cause the processor to perform operations, the operations comprising:
obtaining driver data including gaze data of a driver;
obtaining an environment model based on sensor data;
detecting an object based on a combination of the driver data and the environment model, wherein detecting the object comprises determining, based on the gaze data and the environment model, that a point of gaze of the driver intersects with the object within the environment model;
determining an interaction of the driver with the object based on the combination of the driver data and the environment model; and
activating, based on the interaction, a driver assistance control to control a vehicle.
